(19) United States
(12) Patent Application Publication
(10) Pub. No.: US 2019/0361741 A1
(43) Pub. Date: Nov. 28, 2019

(54) MANAGING RESOURCE SCHEDULING

(71) Applicants: Wade Lukken, Dakota Dunes, SD (US); Grant Wittstruck, Panama City Beach, FL (US)

(72) Inventors: Wade Lukken, Dakota Dunes, SD (US); Grant Wittstruck, Panama City Beach, FL (US)

(21) Appl. No.: 16/420,885

(22) Filed: May 23, 2019

Related U.S. Application Data
(60) Provisional application No. 62/676,132, filed on May 24, 2018.

(51) Int. Cl. G06F 9/50; G06F 21/62

(52) U.S. Cl. CPC G06F 9/5011; G06F 21/6218

(57) ABSTRACT

A resource allocation and scheduling system allows one to schedule one or more resources to one or more users. Aspects of the technology restrict a user's ability to schedule a resource based on a variety of criteria or data associated with the user. In some cases, restriction is based on a comparison to other users. The system may be implemented to schedule operating rooms for surgeons based on past performance of the surgeons.

### PRIORITY CLAIM

This application claims the benefit of U.S. provisional application Ser. No. 62/676,132, filed May 24, 2018, entitled “MANAGING RESOURCE SCHEDULING,” which application is incorporated herein by reference in its entirety.

### BACKGROUND

Computer applications that facilitate scheduling typically allow one person the ability to electronically request a meeting with other people. This electronic request usually comes via email. Resources (e.g., conference rooms) can be electronically assigned to the meeting provided that another person has not booked the resource. Canceling a meeting previously scheduled typically occurs by the organizer of the meeting sending out an electronic cancelation notice, at which point the resource is then released for another to use.

This scheme, however, leads to lost productivity when the resource is necessary, scarce, and valuable. Where a resource requires preparation time to use, the problem is further exacerbated. In particular, if one were to cancel the use of a resource without sufficient time for another to prepare to use the resource, the resource would sit idle and productivity would be lost.

As a non-limiting example, hospital operating rooms are an example of such a resource. Surgeons will typically book a block of time in an operating room to perform a surgery (“Block Time”). Preparations required to make the surgery happen include coordinating a variety of schedules (e.g., a patient's schedule, the surgical team's schedule, other hospital personnel schedules, etc.). Thus, a certain amount of lead time is useful in scheduling Block Time.

Canceling Block Time too close to the actual time of the surgery could leave the operating room empty. Operating rooms tend to be profit centers for hospitals. As such, an empty operating room may lead to lost profits. Accordingly, when a surgeon cancels a surgery and leaves an empty operating room, the hospital may lose money. It thus remains desirous to develop a system that can manage the schedule of valuable resources, such as operating rooms, to reduce idle resources.

It is with respect to these and other general considerations that aspects of the technology have been made. Also, although relatively specific problems may be discussed, it should be understood that the examples should not be limited to solving the specific problems identified in the background or elsewhere in this disclosure.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

A scheduling system is provided to allow users to request and release resources. In aspects of the technology, the user's ability to request and/or secure (e.g., schedule) a resource depends on a variety of factors. These factors include, but are not limited to, past utilization-efficiency rate of the resource by the user, past cancelation rates of the user, user's average number of days lead time prior to the cancelation of scheduled bookings, etc.

In aspects of the technology, a server handles requests from users (e.g., surgeons) to release and request resources (e.g., operating room time). The server may also handle administrative instructions from resource allocators (e.g., hospital administrators), to determine and/or set rules as to when to allocate a resource to a user. The server may then determine, based at least in part on the rules, whether to grant or deny a resource request from a user. If the request is granted, the server will update a master schedule to reflect that the resource has been allocated to the user.

The server may also determine whether to send messages to users informing them of available resources. Sending resource availability messages may occur periodically or based on an event, such as a resource being recently released. For example, the users may set preferences as to how and when they would like to receive notifications related to available resources. The server may store these preferences and use the preferences when determining when/whether to send resource availability to a user.

### BRIEF DESCRIPTION OF THE DRAWINGS

FIG. 1 illustrates an example computer environment in which managing resource scheduling may be implemented.

FIG. 2 illustrates an example system to manage resource scheduling.

FIGS. 3A-3D illustrate an example message scheme to manage resource scheduling.

FIG. 4 is an example method of requesting an allocation of a resource.

FIG. 5 is an example method of releasing a scheduled resource.

FIG. 6 is an example method of selecting message preferences.

FIG. 7 is an example method of setting resource allocation rules.

FIG. 8 is an example method of flagging users based on rules.

FIG. 9 is an example method to determine whether to grant a request for an allocation of a resource.

FIG. 10 is an example method for managing schedules associated with a resource.

FIG. 11 is a method of detecting a scheduling conflict.

FIG. 12 illustrates one example of a suitable operating environment in which one or more of the present embodiments may be implemented.

### DETAILED DESCRIPTION

Various aspects of the disclosure are described more fully below with reference to the accompanying drawings, which form a part hereof, and which show specific example aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems or devices. Accordingly, aspects may take the form of a hardware implementation, an entirely software implementation or an implementation combining software and hardware aspects. The following detailed description is, therefore, not to be taken in a limiting sense.

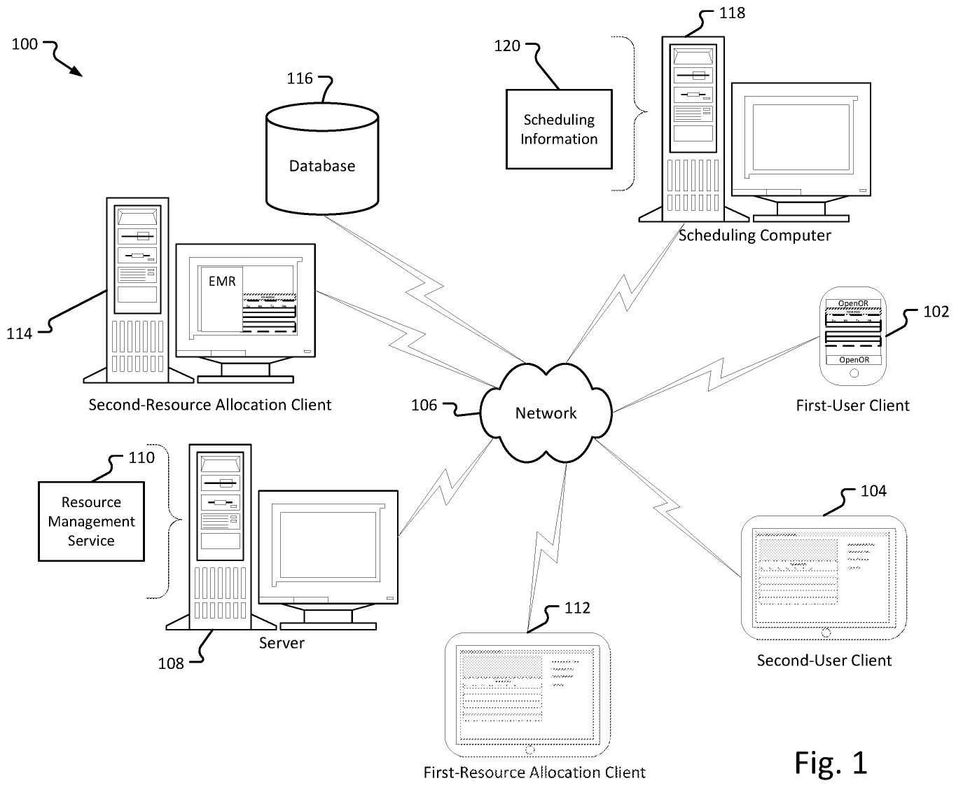

FIG. 1 illustrates an example computer environment 100 in which managing resource scheduling may be implemented. As illustrated, a first user-client 102 and a second user-client 104 are connected to a server 108 through a network 106.

In aspects of the technology, user-clients such as first user-client 102 and second user-client 104 communicate notification preferences, resource requests, and resource releases to the server 108 through the network.

Each user-client may house software that enables the user-client to interface with a user and communicate information to the resource management service 110 running on the server 108. As illustrated, the first user-client 102 is an application running on a mobile device (i.e., a phone application). The second user-client 104 is illustrated as being implemented using a web browser on a tablet. Each of the mobile application and the web browser may be configured to display information, receive information, and communicate information to the resource management service 110. It will be appreciated that a user-client may be instantiated on a variety of computing platforms, including, wired and wireless computing systems, mobile computing systems (e.g., mobile telephones, netbooks, tablet or slate type computers, and laptop computers), and desktop computers, and the like. The user-clients may include physical hardware such as one or more computer processors, memory, communication connections, and input/output devices and can determine and relay viewport and/or active region information.

In aspects of the technology, each resource-allocation client, such as first resource-allocation client 112 and second resource-allocation client 114 communicate resource information to the resource management service 110 through the network 106. The resource information may include the availability of a resource, current users or the resource, and other information related to the resource.

In further aspects of the technology, each resource-allocation client may communicate information related to specific users. This information may include user priority rules (e.g., rules that aid the resource management service 110 in determining whether/when to send a message to a user-client regarding an available resource). The resource-allocation clients may further send information regarding users to the resource management service.

Each resource-allocation client may house software that enables the resource-allocation client to interface with an administrator (e.g., a hospital administrator). For example, the resource-allocation client may receive information from an administrator and communicate the information to the resource management service 110 running on the server 108. As illustrated, the first resource-allocation client 112 is a tablet running a web browser. The second resource-allocation client 114 is illustrated as a personal computer in which the resource-allocation client functionality is embedded in another program (as illustrated, the other program is an Electronic Medical Record System (“EMR”)). Each of the applications and the web browser may be configured to display information, receive information, and communicate information from a user of the resource-allocation client (e.g., an administrator of a hospital) to the resource management service 110. It will be appreciated that resource-allocation client may be instantiated on a variety of computing platforms, including, wired and wireless computing systems, mobile computing systems (e.g., mobile telephones, netbooks, tablet or slate type computers, and laptop computers), and desktop computers, and the like. The resource-allocation clients typically include physical hardware such as one or more computer processors, memory, communication connections, and input/output devices and can determine and relay viewport and/or active region information.

One or more servers, such as server 108, handles requests from both the user-clients and the resource-allocation clients. For example, the server 108 may handle user notification preferences, resource requests, and resource releases using the resource management service 110. To illustrate, the server 108 may receive a resource request, such as a request for operating room Block Time on a particular date and for a particular time, from the second user-client 104. In the event the request is granted, the server 108 may use the resource management service 110 to change a master schedule associated with the resource and relay a message regarding the new allocation of the resource to various resource-allocation clients, such as the first resource-allocation client 112 and the second resource-allocation client 114. Resource release notifications may be similarly handled by the server 108.

The server 108 may further communicate the new allocation of the resource to user-clients. In some aspects of the technology, the server 108 makes a determination as to whether to send the information to user-clients. Further, whether user-clients, such as first user-client 102 and second user-client 104 receive notifications regarding released resources may be determined in part by the user notification preferences. The user notification preferences may be specific to each user-client and may be controlled by each user-client. In additional/alternative embodiments, an administrator associated with a resource-allocation client sets user notification preferences.

The server 108 serves the requests of one or more clients, such as first user-client 102, second user-client 104, first resource-allocation client 112, and second resource-allocation client 114, including the requests as indicated above. In an aspect of the technology, the server 108 is a computer, or series of computers, linked together that serves the requests of other computer programs, such as computer programs of the client(s). The server 108 includes computer programs running to serve the needs of clients. As illustrated, the server includes computer programs enabling the resource management service 110. The server 108 may also include physical hardware such as one or more computer processors, memory, one or more hard drives, communication connections, and input/output devices.

Additionally illustrated is a scheduling server 118. In aspects of the technology, the scheduling server 118 includes scheduling information 120 of one or more users associated with user clients, such as the first-user client and the second user-client. The scheduling information 120 may contain the importance, date, time, location, duration and subject of an event that the user has committed to attend, has been invited to, has been tentatively invited, or otherwise indicated that the user may attend or is busy. The scheduling information may contain other information as well. The scheduling information 120 may be accessed using calendaring extensions to WebDav, CalDav, or other calendaring extension. Other methods of accessing scheduling data now known or later developed may also be used. The scheduling information 120 may be used by the resource allocation clients, the user clients, and/or the resource management service to identify, alert, prevent, and/or notify of potential scheduling conflicts when users attempt to book a resource that conflicts with the scheduling information (e.g., a surgeon attempts to book a resource, but his GOOGLE CALENDAR™ indicates that she is speaking at a conference in another state that same day).

Through the network 106, the clients 102, 104, 112, and 114 each request services from the server 108. For example, the clients may request the server 108 to render a webpage, provide information to an application, or provide information to a plug-in to a larger application. For example, second user-client 104 may request a rendition of a webpage. This webpage may, for example, be a webpage that includes a copy of a schedule associated with the second user and a resource (such as available operating-room time, currently held operating-room time, and unavailable operating-room time). Additionally, the server 108 may respond to requests from the clients by delivering HTML script, applets, C++ code, or other computer instructions.

Additionally, the scheduling server 118 may communicate with the one or more of the server 108, the clients 102, 104, 112, and 114 through the network 106. For example, scheduling information 120 may be pushed to the server 108 and the clients, or pulled from the scheduling server 118 using the network 106.

In an embodiment, a database 116 is connected to the network 106 as well. The database 116, may store a variety of information related to the managing resource scheduling including user data/statistics, copies of resource allocations (e.g., a schedule of use for an operating room), copies of priority rules, etc. Each resource-allocation client, user-client, and server may store or retrieve information on the database 116.

As illustrated, the network 106 facilitates communication between clients, servers, and databases. There are numerous types of networks that one could employ to allow devices to communicate with each other. Communication may occur through the use of wireless and/or other technologies. For example, the network 106 could be the Internet or a local area network (“LAN”). In a particular embodiment, the network 106 may be a tightly coupled business network where the server system is relatively “dedicated” to a small number of computers in a LAN environment.

As a non-limiting example, a user may use a mobile device (e.g., the first user-client 102), to release operating room Block Time (a resource). A message may be sent from the first user-client 104 to the server 108 indicating that the operating room block time is to be released. The resource management service 110 may then update a master schedule associated with the operating room and send the updated schedule (or information sufficient to indicate an updated resource) to clients associated with hospital administrators, such as first resource-allocation client 112 and second resource-allocation client 114. In aspects of the technology, an additional message is sent to the scheduling server 118, either directly or indirectly through the resource management service 110, for example, to reflect that the resource has been released. The scheduling information 120 may be altered, for example.

Continuing with the above example, the resource management service 110 may use priority rules as sent by resource-allocation clients (e.g., clients associated with hospital administrator accounts such as first resource-allocation client 112 and second resource-allocation client 114) as well as message preferences as sent by user-clients (such as a user client associated with surgeons) to determine a set of physicians to send notifications regarding the newly freed Block Time. In other aspects, all user-clients are sent updates as a matter of course.

After receiving a notification that a resource is newly available, a user-client, such as the second user-client 104, may receive input (via a touchscreen, for example) that a user associated with the user-client would like to request the resource. In aspects of the technology, a scheduling check is made against the scheduling information 120 to ensure that the user associated with the user client does not have a scheduling conflict. In the event of a conflict, an alert, notification or error may occur. The scheduling check may be done by communicating directly with the scheduling server or indirectly. In aspects of the technology, a request may be generated from a client, such as a second user-client 104 and sent to the resource management service.

After sending notifications to user-clients, the resource management service 110 may receive a request for the newly available Block Time from a user-client associated with a surgeon (such as second user-client 104). The resource management service 110 may verify, using the priority rules, that the user-client is permitted to assign the block time to the surgeon (i.e., allocate a resource to the user).

After receiving a resource request, the resource management service 110 may make a scheduling check against the user to determine whether the user has a scheduling conflict using the scheduling information 120. In the event of a conflict, an alert, notification or error may occur. The scheduling check may be done by communicating directly with the scheduling server or indirectly. In aspects of the technology, a request for the scheduling information 120 may be generated from a user-client, such as a second user-client 104 and sent to the resource management service 110.

Upon verification, the resource management service 110 may then assign the block time to the surgeon, update the master schedule, and send the update to a plurality of clients, including second resource-allocation client 114 and first resource-allocation client 112. The resource management service 110 may alert the user-client associated with the requesting surgeon that the Block Time has been secured by the surgeon and may further notify other user-clients (such as first user-client 102) that the resource is no longer available. In aspects of the technology, the scheduling information 120 may be updated to indicate that the user requesting the Block Time has reserved the block time and/or that the user is unavailable.

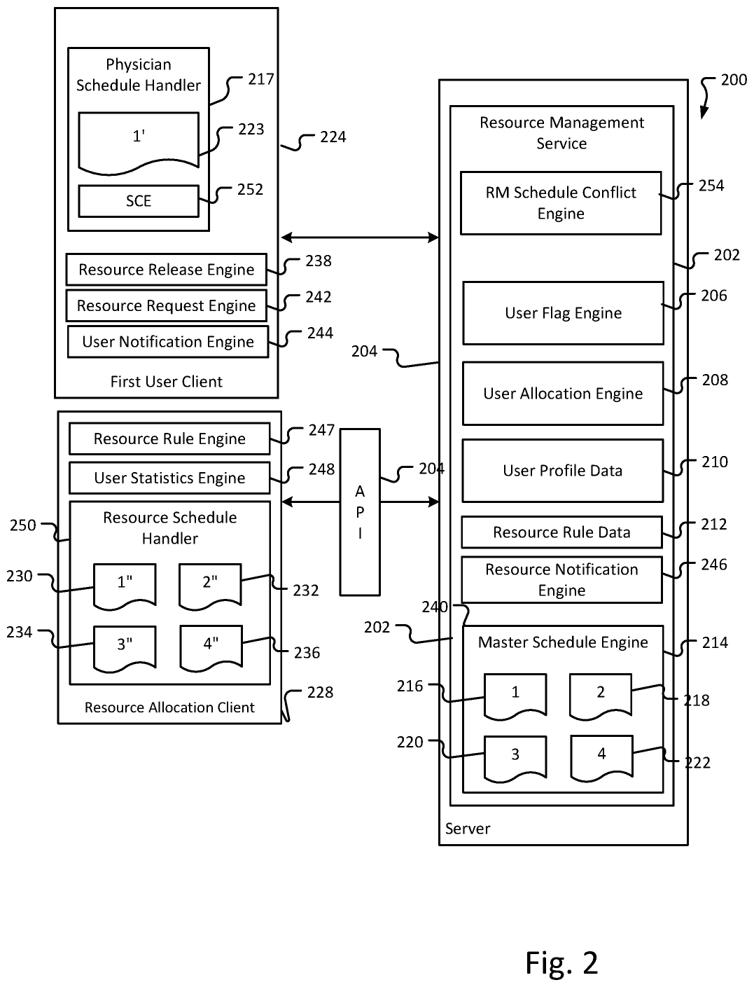

FIG. 2 illustrates an example system 200 to manage resource scheduling. As illustrated, the resource management service 202 is housed on a server 204. The resource management service 202 includes, among other things, a user-flag engine 206, a user allocation engine 208, user profile data 210, resource rule data 212, and a master schedule engine 214.

In aspects of the technology, the user-flag engine 206 assigns flags (i.e., flags a user profile data) to a user's profile based, in part, on the resource rule data 212 and user profile data 210. For example, resource rule data 212 may indicate a set of rules and a corresponding flag. In aspects of the technology, the corresponding flag indicates the type of flag to set when the condition(s) of the rule are met. These rules may be related to a user's past interaction with a resource. The user's past interaction with a resource, for example, may be stored in user profile data 210. Thus, the user-flag engine 206 may use the user profile data 210 to assign a flag to a user based on the resource rule data. Table 1 below provides an example set of rules (which may be stored as resource rule data 212) and associated flags (which may be assigned to user's based on their user profile data 210) that may be used in the context of an operation room:

TABLE I

| Flag | Rule |
|---|---|
| Restricted | Average cancelation lead-time less than X |
| | number of days (e.g., where X is equal to 5 |
| | days, 10 days, 15 days, etc., as set by the |
| | administrator, for example). |
| Normal | Utilization ratio of user's past resource use is |
| | between 85%-115% of mean. |
| Priority | The type of use of the resource is equal to a |
| | specific use (e.g., an operating room is being |
| | requested for a surgery that is highly |
| | specialized or highly profitable surgery). |

To resolve the rule, the user-flag engine 206 may load user profile data of a specific user for analysis. To use the surgeon example, the user-flag engine 206 may load information regarding a particular surgeon's use of one or more operating rooms. The data of the surgeon (loaded as user profile data 210, for example), may have data that indicates they have schedule the operating room 10 times in the past 30 days, and 100 times since the beginning of the creation of the surgeon profile. The user profile data 210 may further indicate that the surgeon has canceled the schedule block time with an average of 28 days of lead time and the surgeon performs normal surgeries (e.g., not specialized and/or highly profitable). The user profile data 210 may further indicate that the current request is for a normal surgery. In such an instance, and following the application of the above rules, the user-flag engine 206 may set a flag of Normal. On the other hand, a surgeon that had user profile data 210 that indicated they had an average lead time of 5 days for operating room cancelations would be flagged as restricted using the example rules provided in Table I.

The rules related to utilization ratio of a resource may be defined by administrator specifications. To continue with the above operating room example, an Electronic Medical Record System (“EMR”) may track the efficiency of a particular surgeon's surgeries, where the efficiency is indicated by the expected time a particular procedure should take divided by the actual time the surgeon blocks. The surgeon's received request for Block Time procedure may be compared against the expected time. If the expected time/actual time is outside a certain ratio (in this case, 0.85-1.15) the surgeon's request may be flagged as restricted. This flag may then be associated with the particular physician and/or the particular request and stored in the user profile data 210.

The user allocation engine 208, in examples, uses the user flag as determined by the user-flag engine 206 to determine whether/when to allocate a resource to a user. For example, a user may request a resource allocation, such as operating room block time. The user allocation engine 208 may identify the flag and associate the flag with a maximum lead time number. The maximum lead time may be provided by a resource allocation client (e.g., a hospital administrator) and stored in resource rule data 212. Table II below indicates an example of the maximum lead time of allocating a resource based on flags. It will be appreciated that the maximum lead time may be altered without deviating from the scope of the innovative technologies described herein.

As a particular example, the user allocation engine 208 may identify that a user has been flagged as restricted, and then limit the user's ability to make a request for a resource to 5 days before the requested day (using Table II).

TABLE II

| Flag | Maximum Lead Time |
|---|---|
| Restricted | 5 days |
| Normal | 25 Days |
| Priority | 90 Days |

A master schedule engine 214 keeps a master schedule of the resource and its allocations to users, such as a first allocation to a first user-client 216, a second allocation to a second user 218, a third allocation to a third user 220, a fourth allocation to a fourth user 222. The allocation comprises data, in examples, that indicates that the resource time has been allocated (e.g., scheduled date, time, duration, location, etc.) to the particular user.

The master schedule engine 214 may distribute information sufficient for a client to appreciate this allocation. For example, the first user-client 224 may receive information sufficient to keep a first copy of first allocation to the first user 223. The first copy of the first allocation to the first user-client 223 may also indicate when the resource is free. In other aspects, the assignments of the resource to other users may be included in the first copy of the first allocation to the first user 223. Where the client is a resource-allocation client such as resource-allocation client 228, the master schedule engine 214 may distribute information sufficient for the resource-allocation client 228 to keep a second copy of the first allocation to a first user 230, a second copy of a second allocation to a second user 232, a second copy of third allocation to a third user 234, and a second copy of a fourth allocation to a fourth user 236. In this way, the master schedule engine may 214 may facilitate the dissemination of information to the appropriate clients.

The first user-client 224 also includes a resource release engine 238. The resource release engine 238 receives indications that the user would like to release an allocation of the resource, such as a first allocation to a first user-client 224. This indication may come via a user interfacing with the first user-client 224 by means of a graphical user interface. The resource release engine 238 may then send a resource release request to the resource management service 202 to request a release of the first allocation to a first-user client 224. The request may be handled by the master schedule engine 240. In this example, the master schedule engine 240 will update the first allocation to a first-user client 224 when the release of the allocation to the first user occurs. The allocation will then, in examples, be indicated as free. Information regarding the release will be sent to the resource notification engine 246 to determine whether and which users will receive information regarding the released allocation, in examples.

In aspects of the technology, the first user-client 224 includes a physician schedule handler 217. The physician schedule handler 217 may use a first copy of the first allocation to the first user-client 223 along with another schedule or calendar information to determine a conflict. This information may be, in examples, be the scheduling information described with respect to FIG. 1. In examples, the schedule conflict engine 252 (SCE) may receive information from a third-party application or other calendar application. If there is a conflict, the SCE 252 may identify the conflict and take an action. In aspects of the technology, the action may be sending an error. The error may be used by a first-user client to notify the user (via a graphical user image alert, a text, or an email, for example) that the user has another event scheduled at the same time that the user is seeking to book (or has booked) the resource. In addition/alternative examples, the action may be to send the user a text, email, or other notification that the user has (or is seeking to) schedule another event (in a third-party calendar application, for example) at the same time the user has scheduled a resource. In other/additional aspects, the error may be used to prevent the user from reserving the resource and/or scheduling the other event. For example, in the case where a user is attempting to schedule the resource, the error may be sent to the resource management service conflict engine 254 which may cause the resource management service to not assign the resource to the user. In other/additional aspects, the SCE 252 displays an indication of a conflict.

The first user-client 224 also includes a resource request engine 242. The resource request engine 242 receives indications that the user would like to request an allocation of a resource. This indication may come via a user interfacing with the first user-client 224 by means of a graphical user interface. The resource request engine 242 may then send a resource allocation request to the resource management service 202 to request an allocation of a resource to the first user. The request may include the time, date, location and/or the duration that the user wishes to have the resource. This request will be handled, in examples, by the user allocation engine 208 using the user profile data and the resource rule data as described above. Where the request is approved, the master schedule engine 240 may send a resource allocation acceptance notice back to the first user. The master schedule engine 240 will store a new allocation to a first user and send information regarding the update to the various clients accordingly.

The first user-client 224 also includes a user notification engine 244. The user notification engine 244 receives indications of a user's preferences with respect to notifications. For example, a graphical user interface may be used to allow a user to interact with a first user-client 224 and indicate when a user would like to be notified when a resource becomes available. For example, the user may indicate to the user notification engine 244 that they would like to receive information regarding an open resource based on the availability of the resource. Specifically, the user may indicate that they only want notifications to be sent when a resource is available for a certain duration of time, a particular day, a particular month, a date range, days of the week, and/or times of day. In additional/alternative examples, the user may indicate they want to receive a notification when a certain type of resource is available (for a certain hospital or particular types of operation rooms, specific operating rooms, etc.). The user preferences are handled by resource notification engine 246.

At the resource management server 204, as illustrated, the resource notification engine 246 receives information from user-clients, including first user-client 224, regarding notification preferences. The resource notification engine 246 stores, in examples, the information in the user profile data 210 and associates the user preferences with the particular user. This may occur using an associative database, for example. When a resource is released, the resource notification engine uses the preferences stored in the user profile data 210 to determine whether to send a notification of the released resource.

The resource-allocation client 228 is illustrated as including a resource rule engine 247. The resource rule engine 247 receives indications from a user (such as a hospital administrator) regarding rules associated with allocating a resource. For example, the rules discussed above with reference to the resource rule data 212 may have been received by the resource rule engine 247 and sent to the resource management service 202.

The resource-allocation client 228 may additionally including user statistics engine 248. The user statistics engine 248 may gather information related to a user's use of the resource. The user statistics engine 248 may be a plugin that interfaces with another computing system. To continue the operating room example, an EMR system may be implemented to monitor use of the resource (e.g., an operating room) by a surgeon. This may include whether the surgeon used more than the allocated time on the resource, whether the surgeon used less than the allocated time, whether the surgeon was less efficient than peers, etc. This information may be sent to the resource management service and stored in the user profile data 210.

The resource schedule handler 250 maintains a copy of the various resource allocations, and handles updates to those allocations when received, such as when received by the resource management service 202. The resource schedule handler may update the plurality of the schedule copies (e.g., a second copy of the first allocation to a first user 230, a second copy of a second allocation to a second user 232, a second copy of third allocation to a third user 234, and a second copy of a fourth allocation to a fourth user 236).

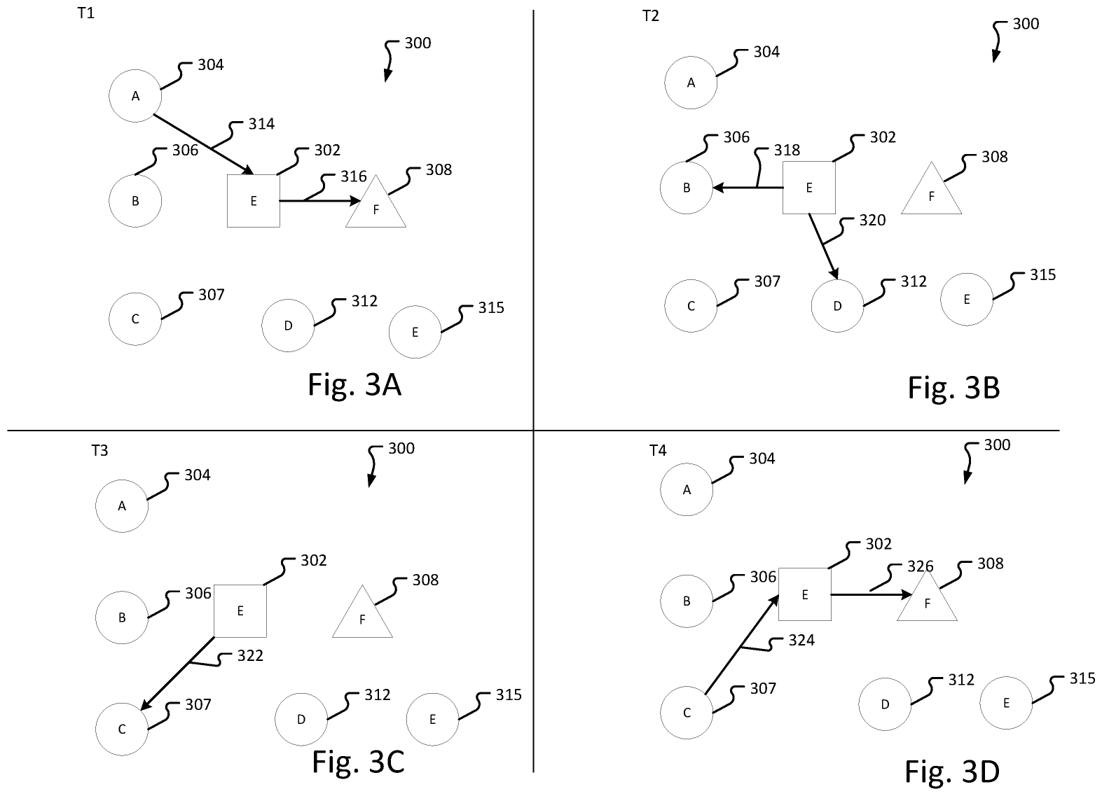

FIGS. 3A-3D illustrate an example message scheme to manage resource scheduling. FIG. 3A represents a networked system 300 at time T1, FIG. 3B represents a networked system 300 at T2, FIG. 3C represents a networked system 300 at T3, and FIG. 3D represents a networked system at T4. Illustrated in each of FIGS. 3A-3D is a server 302 (which may be running management service that is the same or similar to the source management service described above). Additionally illustrated are first user-client 304, second user-client 306, third user-client 307, fourth user-client 312, and fifth user-client 315. Further a resource-allocation client 308 is also illustrated.

As illustrated, at T1 the first user-client 304 sends a resource release notification 314. The resource release notification may include a time stamp indicating the time the resource release notification 314 was made as well as information used to process the request (e.g., an identifier of the resource and data describing the allocation of the resource to the user (date and time the resource was scheduled to be used)). The request is received by the server 302. A released resource message 316 is forwarded to the resource-allocation client 308. The released resource message 316 may include the same or similar information that was in the resource release notification 314. In this manner, both the server 302 and the resource-allocation client 308 have information indicating the timing of the resource release notification 314 as well as the information sufficient to update a schedule associated with the resource to indicate that the resource is no longer allocated to the user at the previously allotted time and date.

The server 302 may determine, using the resource management service, which of the other user-clients to send a notification regarding the released resource. For example, and continuing with the operating room example, the server may determine which user-client to send information regarding the recently open Block Time. As illustrated, a first resource availability message 318 and a second resource availability message 320 are sent to the second user-client 306 and the fourth user-client 312, respectively. The determination as to which user-clients to send to a resource availability message may be made by determining whether a user is permitted to request a resource allocation and/or checking the user notification preferences. For example, second user-client 306, third user-client 307, and fourth user-client 312 may have indicated that they would like updates regarding a resource release. Fifth user-client 315 may have requested not to receive notifications. The second user-client 306, the fourth user-client 312, and the fifth user-client 315 may all be eligible to request a resource at time T2 (e.g., they were flagged as priority and the priority flags indicates a sufficient lead time has been met). The third user-client 307 may not be eligible to request a resource at T2 (e.g., the third user-client 307 may be flagged as restricted). In such a scenario, the server 302 may determine not to send an availability message to third user-client 307 because the third user-client 307 is ineligible to have the resource allocated at the recently released time. The server 302 may additionally decide not to send an availability message to the fifth user-client 315 because the fifth user-client 315 indicated that it did not want to receive such messages.

At time T3, a sufficient amount of time may have passed so that third user-client 307 is eligible for a resource allocation. The server 302 may determine this and send a third resource availability message 322 to the third user-client. This may occur after the server 302 has determined that it has not received a resource allocation request message from any other client that is permitted to make such a request, such as the second user-client 306 and the fourth user-client 312.

As illustrated, at time T4, the third user-client 307 sends a resource allocation request message 324 to the server 302 indicating that it would like the resource allocation recently that was initially released by the first user-client 304. The server 302 determines that the third user-client 307 is permitted to make such a request, allocates the resource, and sends an allocation message 326 indicating the new resource allocation to the resource-allocation client 308. Other messages may then be sent to the other clients indicating that the resource is no longer available during the time that has been allocated to the third user-client 307.

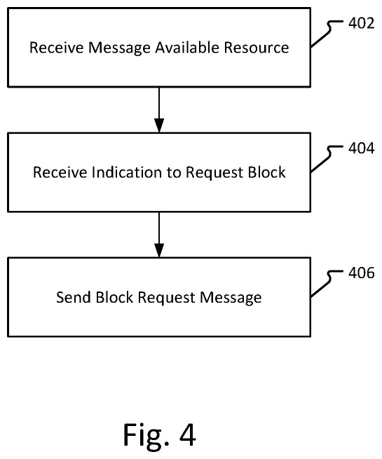

FIG. 4 is an example method 400 of requesting an allocation of a resource. Method 400 begins with receive message of available resource operation 402. The message may be received by a user-client, for example. In operation 402, a message is received indicating that a resource is available. The message may include a unique resource identifier and the times and dates that the resource is available. In additional/alternative embodiments, the message may be an update to the availability of a resource.

The method 400 then proceeds to receive indication to request resource operation 404. In operation 404, an indication indicating a time at which the user would like to use the resource, the date on which the user would like to use the resource, and an identifier of the resource is received. In aspects of the technology, a graphical user at a user-client is used to receive the indication (e.g., a user uses a mouse and keyboard to indicate she wants to book an operating room). The indication is then stored and packaged for messaging to a resource management service.

The method 400 then proceeds to send resource request message operation 406. In operation 406, the packaged information is sent to a resource management service, which may be housed on a server.

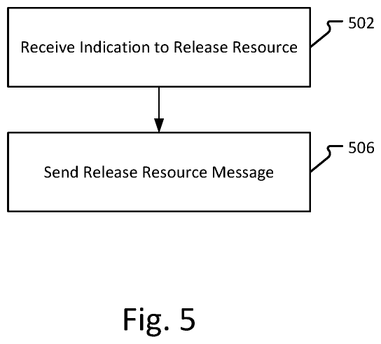

FIG. 5 is an example method 500 of releasing a scheduled resource. Method 500 begins with receiving an indication to release a resource operation 502. The indication may include a time duration to release, a date of the time duration, and the unique resource identifier. Additionally/alternatively, the allocation may be released by identifying the allocation by a unique identifier known to a resource management service.

Method 500 then proceeds to operation 504, where the information received at operation 502 is packaged and sent to a resource management service. In aspects of the technology, the resource management service may be housed on a server.

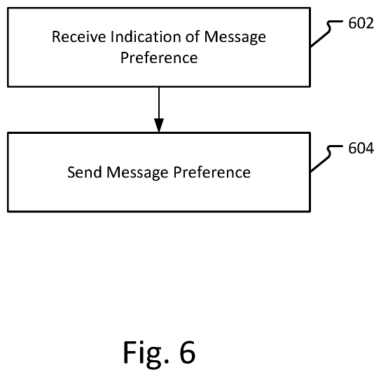

FIG. 6 is an example method 600 of selecting message preferences. Method 600 begins with operation 602 where an indication of message preferences is received. For example, the indication may be inputted by a user into a GUI of a user-client device. The message preferences allow a user to set when the user would like to receive information regarding the availability of a resource. Table 3 provides an example of types of message preferences that a user may set:

TABLE III

| User Preference | Example |
|---|---|
| Days of Week | User indicates that they want to receive |
| | updates regarding resources that become |
| | available on Sunday, Monday, or Wednesday. |
| Time of Day | User indicates that they do not want to receive |
| | updates regarding resources that become |
| | available before noon. |
| Month | User indicates that they do not want to receive |
| | updates regarding resources that become |
| | available in July. |
| Type of resource | User indicates that they only want to receive |
| | updates regarding operating rooms that can |
| | handle limb surgery. |

Method 600 then proceeds to send message preference operation 604. In operation 604, a message is sent that indicates the user's preference. In aspects, the message includes information sufficient to identify the user and the preference. The message may be sent to a resource management service housed on a server.

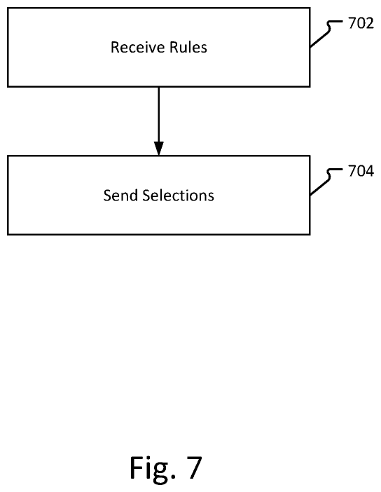

FIG. 7 is an example method 700 of setting resource allocation rules. Method 700 begins with receive rules operation 702. In aspects of the technology, the rules are received by a resource-allocation client. Example rule options are presented in Table 4 below:

TABLE IV

| Rule | Example |
|---|---|
| Resource Allocation lead time Restricted by | Surgeons using specific operating room for |
| Resource Use | limb surgery allowed to book specific |
| | operating room 30 days in advance, whereas |
| | surgeons using specific operation room for |
| | facial surgeries allowed to book specific |
| | operating room 15 days in advance. |
| Resource allocation lead time restricted if | Surgeons that have an average cancelation |
| user, on average, has previously canceled | days of less than 10 days are restricted to |
| resource without sufficient lead time | requesting an operating room to within 10 |
| | days. |
| Resource allocation lead time restricted based | Surgeons who have a 75% failure rate of |
| on other performance | completing notes within 3 days of surgery are |
| | restricted to requesting operating room to |
| | within 5 days of request. |
| Define Flag Categories | Administrator sets the number and label of |
| | flags, such as restricted, priority, and normal |
| | along with the specific criteria to meet those |
| | flags as described above with reference to |
| | Table I. |
| Define Flag Lead Time | Administrator sets the maximum number of |
| | days of lead time for each flag category, such |
| | as the maximum number of days of lead time |
| | as described with reference to Table II above. |

Method 700 then proceeds to send selections operation 704. In operation 704, the rules are sent to a resource management service. The resource management service may be housed on one or more servers.

It will be appreciated that the aspects of the technology are not so limited as to the rules provided in table 4. Rather, it will be appreciated that other schemes may be implemented to restrict scheduling of a resource based on user data.

For example, a scoring scheme may be implemented to give users scores. Points may be awarded or deducted based on user captured data, which data is representative of user behavior. For example, points may be awarded/deducted based on timeliness (e.g., arriving 15 minutes prior to first case may be awarded 10 points, arriving late would be −10), utilization of resource (e.g., using a resource greater than 70% of the time that the user scheduled results in 10 points, less than 20% would be −10), timely release of a resource (e.g., releasing a schedule resource 90 days out results in 20 points, 30 days out results in 5 points, within a week −10), or other specific behavior (average calls per month to an operating room to scrub is zero results in 10 points, greater than 1.5 would be −10). The points may be used to determine a category (e.g., a flag) of the user. For example, the points may be compared to an absolute point categorization system (e.g., users having >100 points are gold, users having >50 points are silver, etc.) or may be compared to other users (e.g., users having top 30% of points will be ranked platinum, users having between 30 and 60% of points gold, etc.) Flags may be set according to the categorization rules. The flags may be used to define resource allocation rules as described above.

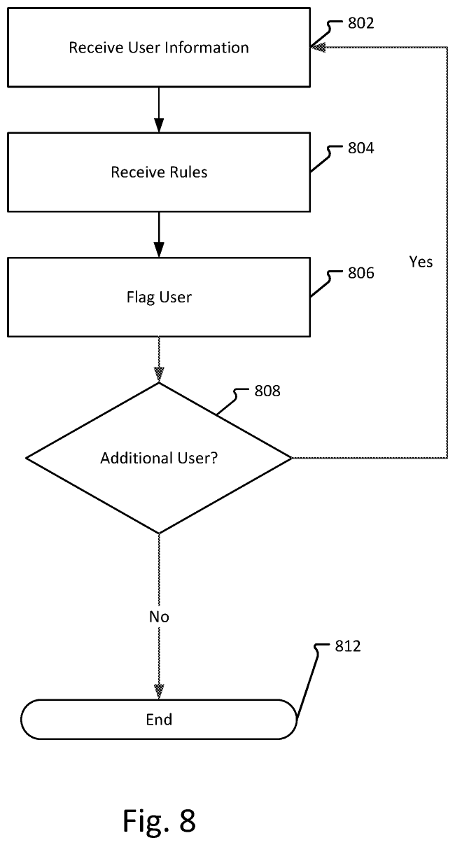

FIG. 8 is an example method 800 of flagging users based on rules. The method 800 begins with operation 802 where user's information is received. User information may include information related to how a user has utilized a resource, such as the number of times a user has canceled the use of a scheduled resource, the utilization ratio of the resource, etc. The information may also include other information about a user unrelated to the resource that may be nevertheless considered during flagging of the user.

The method 800 then proceeds to receive rules operation 804. In operation 804, rules are received. The rules may be obtained or received from a database. The rules may be determined in part or all by a resource-allocation client.

The method 800 then proceeds to operation 806 where the user is flagged based on the rules. For example, users may be categorized into one of several categories based on applying the rules received in operation 804 to the user data. In an aspect of the invention, a user is categorized as either restricted access, free access, or priority access. These categories may be used to determine whether a user is able to book a resource far in advance. For example, restricted access may be restricted to obtaining a resource allocation 15 days in advance of the user's intended use of the resource, free access may be restricted to obtaining a resource allocation 30 days in advance of the user's intended use of the resource, and priority access may be restricted to obtaining a resource allocation 60 days in advance of the user's intended use of the resource.

Method 800 then proceeds to determination 808. In determination operation 808, it is determined whether there are additional users to flag. Where there are additional users to flag, the method returns to operation 802, where the additional user's information is received. Where there are no additional users to flag, the method 800 ends.

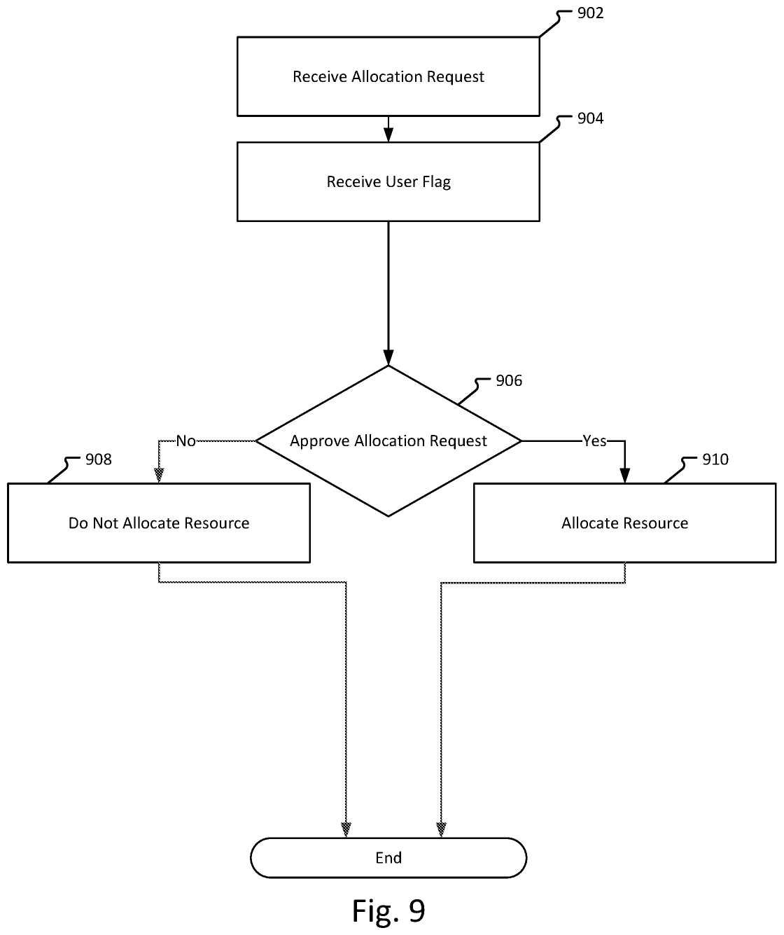

FIG. 9 is an example method 900 to determine whether to grant a request for an allocation of a resource. The method begins with receive an allocation request operation 902. In operation 902, an allocation request is received. The allocation request may include a unique identifier of the resource, the unique identifier of the user, and the time and date that the user would like to use the resource. The request may come from a user client.

Method 900 then proceeds to receive user-flag operation 904. In operation 904, flags are received that are associated with a user. For example, a user may be flagged as restricted or priority. These flags may be used to determine whether the message is sent out. For example, a user that is flagged as restricted may not be able to reserve a resource (i.e., receive an allocation to the resource) far in advance. As a specific, non-limiting example, a user may be restricted to reserving a resource within 15 days of the requested time when the user is flagged as restricted. On the other hand, a user without restrictions (or a priority user) may be able to reserve a resource far in advance of the day in which the user intends to use the resource, such as 30 days.

Method 900 then proceeds to approve request determination 906. In determination 906 the user flags along with the information included in the allocation request (such as the time and date that the user would like to use the resource) are used to make a determination as to whether to allocate the resource. In some aspects, amount of resource-allocation lead time that a user is permitted (as determined by the user flag) is compared to the actual amount of lead time. For example, if a user is permitted to have a resource allocated to the user no more than 15 days out from the time the resource has been requested, but the request is actually 16 days out, it may be determined that the request should be denied. Alternatively, if a user is permitted to have a resource allocated to the user no more than 15 days out from the time the resource has been requested, but the request is 14 days out, it may be determined that the request should be approved.

Where the determination 906 indicates that the request is to be denied, the operation proceeds to do not allocate resource operation. The request may be queued and a timer may be established that counts down until the time the user would be available to make such a request. Continuing with the above example where the request was denied because the user requested with 16 days lead time and the maximum number of days lead time was 15, a timer may be set for 1 day. At the expiration of the timer, and after determining that the resource is still available at the requested time and date, a notification may be sent to the user indicating the same. Where the determination 908 indicates that the request is to be granted, the operation proceeds to allocate resource 910, where the resource is allocated to the user at the time and date requested.

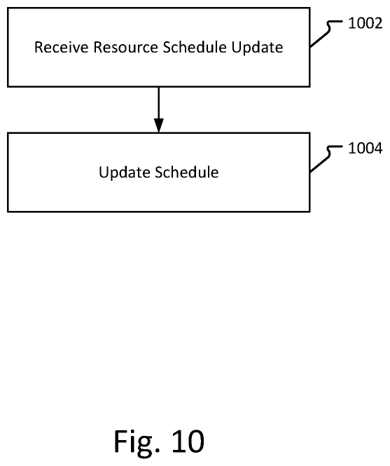

FIG. 10 is an example method 1000 for managing schedules associated with a resource. Method 1000 begins with receive resource schedule update operation 1002. The message may indicate that a resource is booked or released. The message may be received from a server housing a resource management service as described above.

The method then proceeds to update schedule operation 1004. In operation 1004, the schedule of the resource is updated to reflect the allocation or release thereof.

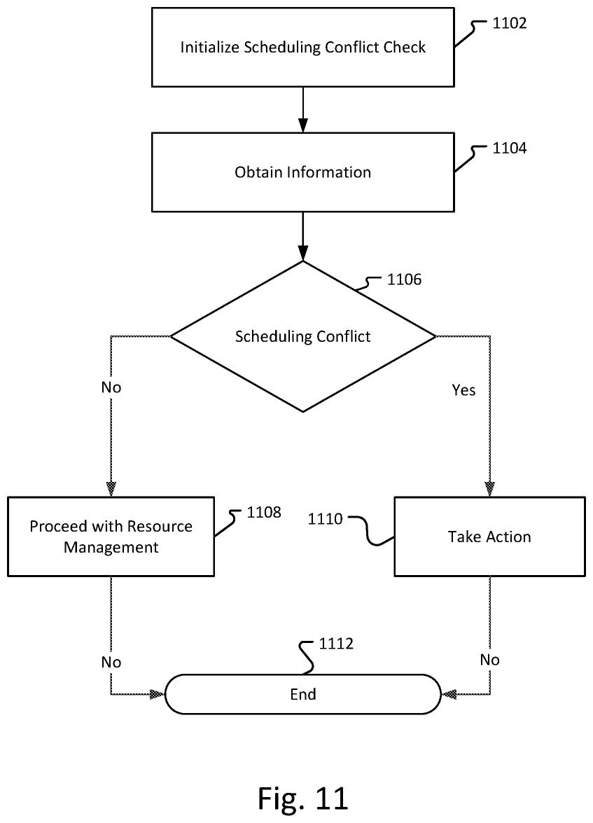

FIG. 11 is a method 1100 of detecting a scheduling conflict. Method 1100 begins with initialize scheduling conflict check operation 1102. A scheduling conflict check may be initialized upon an event (e.g., a resource management service receiving/obtaining a resource request, a resource management service receiving/obtaining receiving other scheduling information, a user making a request to check conflict) or at a specific time (e.g., every morning at 8 AM, hourly, weekly, etc.).

The operation then proceeds to obtain information operation 1104. In operation 1104 information related to the user's schedule is obtain. This may include receive resource allocations associated with a user, resource requests of a user, and/or other schedule information that includes user scheduled events. The user scheduled events may be a calendar event from another program or application (such as GOOGLE CALENDAR™ or OUTLOOK™). In the event that the schedule event is obtained from another program or application, the resource management service may obtain scheduling information on a cycle (e.g., every twenty four hours) or on event (e.g., when a user attempts to book a resource, upon connection with a resource management service, upon request of a user, etc.). The information obtained may be obtained using Internet Calendaring and Scheduling Core Object Specification or other protocol or specification.

The resource request may be received at and/or obtained from a user-client, a resource allocation client, and/or a resource management service. The resource allocation allocated to the user may similarly be obtained/received a user-client, a resource allocation client, and/or a resource management service. The schedule event may include the date, time, duration, unique identifier, etc. of a resource that a user wishes to be allocated.

At determination 1106, the scheduling data, the resource allocation, and/or the information in the resource request is used to determine a conflict. For example, if the resource request occurs at the same time as another event that is scheduled, it may be determined that a scheduling conflict exists. Even where the time of a resource request and a scheduled event do not overlap, it may be determined that the locations of the two events are too far apart given the time separating the two events, and may determine there is a scheduling conflict. Similarly, if a user has a pending event (e.g., an invitation) or new event scheduled indicated by the scheduling information at the time same or similar time as an allocation of a resource, it may be determined that there is a conflict.

Where a scheduling conflict does not exist, method 1100 proceeds to operation 1108, where the schedule management proceeds without conflict. This may include processing a scheduling request, updating a copy of a resource allocation, updating a user schedule, or taking no action.

Where a scheduling conflict does exits, method 1100 proceeds to operation 1100, where an action is taken. The action may generate an error, alert a user of scheduling conflict (via email, SMS text, graphical display, sound, etc.), prevent resource request from being delivered to resource management service, or other action as deemed appropriate.

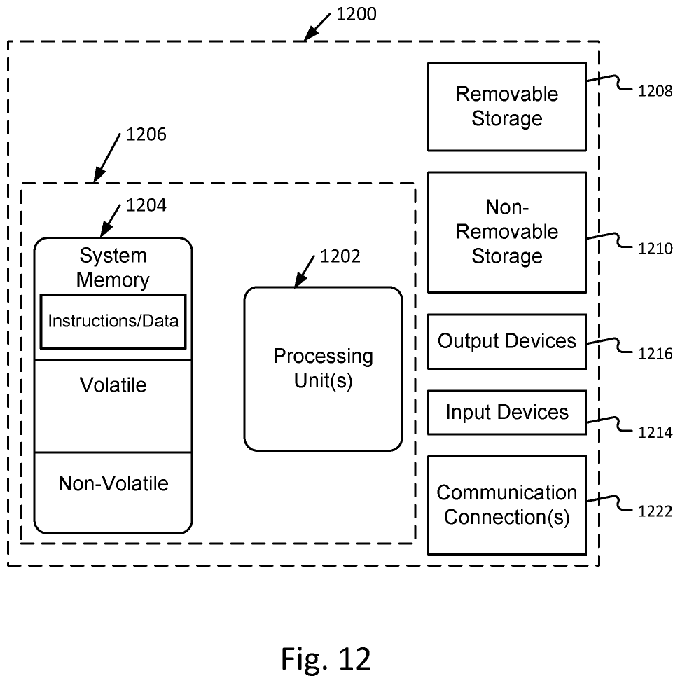

FIG. 12 illustrates one example of a suitable operating environment 1200 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 1200 typically includes at least one processing unit 1202 and memory 1204. Depending on the exact configuration and type of computing device, memory 1104 (storing, among other things, notification data, anti-exploit code/data, instructions to perform the methods disclosed herein, etc.) may be volatile (such as RAM), non-volatile (such as ROM, flash memory, etc.), or some combination of the two. This most basic configuration is illustrated in FIG. 12 by dashed line 1206. Further, environment 1200 may also include storage devices (removable, 1208, and/or non-removable, 1210) including, but not limited to, magnetic or optical disks or tape. Similarly, environment 1200 may also have input device(s) 1214 such as keyboard, mouse, pen, voice input, etc. and/or output device(s) 1216 such as a display, speakers, printer, etc. Also included in the environment may be one or more communication connections, 1212, such as LAN, WAN, point to point, etc.

Operating environment 1200 may include at least some form of computer readable media. Computer readable media can be any available media that can be accessed by processing unit 1202 or other devices comprising the operating environment. By way of example, and not limitation, computer readable media may comprise computer storage media and communication media. Computer storage media includes volatile and nonvolatile, removable and nonremovable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The operating environment 1200 may be a single computer operating in a networked environment using logical connections to one or more remote computers. The remote compute may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broadest scope of the claimed disclosure.

What is claimed:

1. A computer implemented method comprising:
receiving a request for an allocation of a resource, the request for an allocation of a resource including a user identification associated with a user, a time stamp of the request, and a date and time of the requested allocation;
receiving a flag associated with the user, the flag indicative of a maximum number of days of lead time;
determining a difference in time between the time stamp of the request and the time of the requested allocation; and
comparing the difference with the maximum number of days of lead time.

2. The computer implemented method of claim 1, further comprising:
based on comparing the difference, determining that maximum number of days of lead time is less than the difference; and
denying the request.

3. The computer implemented method of claim 2, further comprising:
determining notification time by finding a second difference between the maximum number of days of lead time and the difference;
setting a timer to expire at the notification time;
after the expiration of the timer, determining that the resource is available at the date and time of the requested allocation; and
sending a notification to a client associated with the user that the resource is available at the date and time of the requested allocation.

4. The computer implemented method of claim 1, further comprising:
based on comparing the difference, determining that maximum number of days of lead time is greater than the difference; and
approving the request.

5. The computer implemented method of claim 4, further comprising:
sending an update to a schedule associated with the resource to indicate that the resource has a new allocation, update comprising the date and time of the requested allocation.

6. The computer implemented method of claim 5, further comprising:
receiving scheduling information, the scheduling information comprising a scheduled event;
determining that a date and time of the scheduled event overlaps with the date and time of the requested allocation;
and taking an action based on the determination.

7. The method of claim 6, wherein the action is at least one of sending a text message to the user, sending an email to the user, displaying a graphical image, and sounding an audible alarm.

8. A system comprising a processor in electronic communication with a computer storage device, the computer storage device storing instructions that, when executed, perform the method of:
receiving a request for an allocation of a resource, the request for an allocation of a resource including a user identification associated with a user, a time stamp of the request, and a date and time of the requested allocation;
receiving a flag associated with the user, the flag indicative of a maximum number of days of lead time;
determining a difference in time between the time stamp of the request and the time of the requested allocation; and
comparing the difference with the maximum number of days of lead time.

9. The system of claim 8, the method further comprising:
based on comparing the difference, determining that maximum number of days of lead time is less than the difference; and
denying the request.

10. The system of claim 9, the method further comprising:
determining notification time by finding a second difference between the maximum number of days of lead time and the difference;
setting a timer to expire at the notification time;
after the expiration of the timer, determining that the resource is available at the date and time of the requested allocation;
sending a notification to a client associated with the user that the resource is available at the date and time of the requested allocation.

11. The system of claim 8, further comprising:
based on comparing the difference, determining that maximum number of days of lead time is greater than the difference; and
approving the request.

12. The computer implemented method of claim 11, further comprising:
sending an update to a schedule associated with the resource to indicate that the resource has a new allocation, update comprising the date and time of the requested allocation.

13. The system of claim 12, the method further comprising:
receiving scheduling information, the scheduling information comprising a scheduled event;
determining that a date and time of the scheduled event overlaps with the date and time of the requested allocation;
and taking an action based on the determination.

14. The system of claim 13, wherein the action is at least one of sending a text message to the user, sending an email to the user, displaying a graphical image, and sounding an audible alarm.

15. A computer storage device storing instructions that, when executed, are capable of performing a method, the method comprising:
receiving a request to release an allocation, the request including a user identification associated with a user, a time stamp of the request, and a date and time of the released allocation;
releasing the allocation;
making a first determination to send a first notification regarding the released allocation to a first set of user-clients, wherein the first determination is made in part by a first flag associated with each user in the first set and first preferences associated with each user in the first set; and
sending the first notification to each user in the first set of users.

16. The computer storage device of claim 15, wherein the flag is a priority flag.

17. The computer storage device of claim 16, further comprising:
waiting until a priority flag timer has expired;
determining a second set of user-clients to send a notification regarding the released allocation, wherein the determining is made in part by a second flag associated with each user in the second set and second preferences associated with each user in the second set; and
sending the second notification to each user in the second set of users.

18. The computer storage device of claim 17, wherein the second flag is a restricted flag.
